(19) United States
(12) Patent Application Publication
(10) Pub. No.: US 2025/0247764 A1
(43) Pub. Date: Jul. 31, 2025

(54) CONDITIONAL EXECUTION OF CELL HANDOVER

(71) Applicant: Lenovo (Singapore) Pte. Limited, Singapore (SG)

(72) Inventors: Prateek Basu Mallick, Dreieich (DE); Joachim Löhr, Wiesbaden (DE)

(73) Assignee: Lenovo (Singapore) Pte. Limited, Singapore (SG)

(21) Appl. No.: 19/034,097

(22) Filed: Jan. 22, 2025

Related U.S. Application Data
(60) Provisional application No. 63/624,915, filed on Jan. 25, 2024.

(51) Int. Cl. H04W 36/36; H04W 36/00; H04W 74/0833; H04W 76/27

(52) U.S. Cl. CPC H04W 36/362; H04W 36/0072; H04W 74/0833; H04W 76/27

(57) ABSTRACT

Various aspects of the present disclosure relate to conditional execution of cell handover. The techniques discussed herein describe conditional handover using lower-layered signaling (e.g., L1 or L2). In one or more implementations, the UE starts a timer, which may have been configured earlier in a conditional configuration message (also referred to herein as a conditional reconfiguration message) received from a network equipment. If a timing advance (TA) value for a first candidate cell is received before the expiry of this timer, the UE transmits handover completion to the first candidate cell. However, if a TA value for the first candidate cell is received after the expiry of this timer, the UE considers the one or more conditions for the first candidate cell as not fulfilled and may invalidate the TA value and start a fresh evaluation or measurement of the one or more conditions.

### RELATED APPLICATION

This application claims priority to U.S. Patent Application Ser. No. 63/624,915 filed Jan. 25, 2024 entitled “CONDITIONAL EXECUTION OF CELL HANDOVER,” the disclosure of which is incorporated by reference herein in its entirety.

### TECHNICAL FIELD

The present disclosure relates to wireless communications, and more specifically to conditional execution of cell handover.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

When a UE moves from the coverage area of one cell to another cell, at some point a serving cell change is performed as a current serving cell does not remain a radio viable option. This serving cell change is referred to as handover or cell handover.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive, from a serving cell, a first signaling that indicates one or more physical random access channel (PRACH) resources and one or more execution conditions for at least one candidate cell; receive, from the serving cell, a second signaling that indicates to the UE to initiate an early timing advance (TA) procedure for a first candidate cell of the at least one candidate cell; start a timer; and transmit, to the first candidate cell, a third signaling that includes a handover complete message if a TA value is received prior to expiration of the timer and the one or more execution conditions for the first candidate cell are satisfied, or invalidate the TA value if the TA value is received after the timer expires.

A processor (e.g., a standalone processor chipset, or a component of a UE) for wireless communication is described. The processor may be configured to, capable of, or operable to perform one or more operations as described herein. For example, the processor may be configured to, capable of, or operable to receive, from a serving cell, a first signaling that indicates one or more PRACH resources and one or more execution conditions for at least one candidate cell; receive, from the serving cell, a second signaling that indicates to the processor to initiate an early TA procedure for a first candidate cell of the at least one candidate cell; start a timer; and transmit, to the first candidate cell, a third signaling that includes a handover complete message if a TA value is received prior to expiration of the timer and the one or more execution conditions for the first candidate cell are satisfied, or invalidate the TA value if the TA value is received after the timer expires.

A method performed or performable by a UE for wireless communication is described. The method may include receiving, from a serving cell, a first signaling that indicates one or more PRACH resources and one or more execution conditions for at least one candidate cell; receiving, from the serving cell, a second signaling that indicates to the UE to initiate an early TA procedure for a first candidate cell of the at least one candidate cell; starting a timer; and transmitting, to the first candidate cell, a third signaling that includes a handover complete message if a TA value is received prior to expiration of the timer and the one or more execution conditions for the first candidate cell are satisfied, or invalidate the TA value if the TA value is received after the timer expires.

In some implementations of the UE, the processor, and the method described herein, the first signaling indicates a duration of the timer.

In some implementations of the UE, the processor, and the method described herein, the first signaling comprises a layer 3 radio resource control (RRC) reconfiguration message.

In some implementations of the UE, the processor, and the method described herein, the handover complete message comprises a layer 3 RRC Reconfiguration complete message.

In some implementations of the UE, processor, and method described herein, the UE, processor, and method may further be configured to, capable of, performed, performable, or operable to transmit, to the first candidate cell, a fourth signaling that includes a random access channel (RACH) message 1; and receive, from the serving cell, a fifth signaling that includes the TA value for the first candidate cell.

In some implementations of the UE, the processor, and the method described herein, the fifth signaling comprises a lower layer medium access control (MAC) control element (CE).

In some implementations of the UE, the processor, and the method described herein, the MAC CE includes an identification of the first candidate cell including a target frequency and cell identity, a physical beam indication, the timing advance, or a combination thereof for transmitting the third signaling.

In some implementations of the UE, processor, and method described herein, the UE, processor, and method may further be configured to, capable of, performed, performable, or operable to start the timer in response to the one or more execution conditions for the first candidate cell being satisfied.

In some implementations of the UE, processor, and method described herein, the UE, processor, and method may further be configured to, capable of, performed, performable, or operable to evaluate measurements of one or more signals received from the at least one cell; and determine, based on the measurements, whether the one or more execution conditions for the at least one cell are satisfied.

In some implementations of the UE, the processor, and the method described herein, the second signaling comprises a physical downlink control channel (PDCCH) order.

In some implementations of the UE, processor, and method described herein, the UE, processor, and method may further be configured to, capable of, performed, performable, or operable to start the timer in response to receiving the TA value from the serving cell.

In some implementations of the UE, the processor, and the method described herein, the at least one candidate cell comprises multiple candidate cells, and the UE, processor, and method may further be configured to, capable of, performed, performable, or operable to prioritize the multiple candidate cells according to one or more criteria; and select, as the first candidate cell, one of the multiple candidate cells having a highest priority.

In some implementations of the UE, the processor, and the method described herein, the one or more criteria include an order or sequence of the multiple candidate cells or frequencies of the multiple candidate cells.

In some implementations of the UE, the processor, and the method described herein, the one or more criteria include a time of when, for each of the multiple candidate cells, the one or more execution conditions for the candidate cell are satisfied.

In some implementations of the UE, the processor, and the method described herein, the one or more criteria include a time of when, for each of the multiple candidate cells, the TA for the candidate cell is received.

An NE (e.g., a base station) for wireless communication is described. The NE may be configured to, capable of, or operable to perform one or more operations as described herein. For example, the NE may be configured to, capable of, or operable to transmit, to a UE, a first signaling that indicates a conditional configuration for at least one candidate cell including a timer, one or more PRACH resources, and one or more execution conditions for the at least one candidate cell; transmit, to the UE, a second signaling that indicates to the UE to initiate an early TA procedure for a first candidate cell of the at least one candidate cell; receive, from the first candidate cell of the at least one candidate cell, a third signaling indicating a TA value; and transmit, to the UE, a fourth signaling indicating the received TA value.

A processor (e.g., a standalone processor chipset, or a component of a NE (e.g., a base station)) for wireless communication is described. The processor may be configured to, capable of, or operable to perform one or more operations as described herein. For example, the processor may be configured to, capable of, or operable to transmit, to a UE, a first signaling that indicates a conditional configuration for at least one candidate cell including a timer, one or more PRACH resources, and one or more execution conditions for the at least one candidate cell; transmit, to the UE, a second signaling that indicates to the UE to initiate an early TA procedure for a first candidate cell of the at least one candidate cell; receive, from the first candidate cell of the at least one candidate cell, a third signaling indicating a TA value; and transmit, to the UE, a fourth signaling indicating the received TA value.

A method performed or performable by an NE (e.g., a base station) for wireless communication is described. The method may include transmitting, to a UE, a first signaling that indicates a conditional configuration for at least one candidate cell including a timer, one or more PRACH resources, and one or more execution conditions for the at least one candidate cell; transmitting, to the UE, a second signaling that indicates to the UE to initiate an early TA procedure for a first candidate cell of the at least one candidate cell; receiving, from the first candidate cell of the at least one candidate cell, a third signaling indicating a TA value; and transmitting, to the UE, a fourth signaling indicating the received TA value.

In some implementations of the UE, processor, and method described herein, the first signaling indicates a duration of the timer.

In some implementations of the UE, processor, and method described herein, the first signaling comprises a layer 3 RRC reconfiguration message.

In some implementations of the UE, processor, and method described herein, the fourth signaling comprises a lower layer MAC CE.

In some implementations of the UE, processor, and method described herein, the MAC CE includes an identification of the first candidate cell including a target frequency and cell identity, a physical beam indication, the TA, or a combination thereof.

In some implementations of the UE, processor, and method described herein, the second signaling comprises a PDCCH order.

### BRIEF DESCRIPTION OF THE DRAWINGS

FIG. 1 illustrates an example of a wireless communications system in accordance with aspects of the present disclosure.

FIG. 2 illustrates an example lower-layer triggered mobility (LTM) procedure in accordance with aspects of the present disclosure.

FIG. 3 illustrates an example of an RRC based conditional reconfiguration message in accordance with aspects of the present disclosure.

FIG. 4 illustrates an example scenario of conditional LTM in accordance with aspects of the present disclosure.

FIG. 5 illustrates another example scenario of conditional LTM in accordance with aspects of the present disclosure.

FIG. 6 illustrates another example scenario of conditional LTM in accordance with aspects of the present disclosure.

FIG. 7 illustrates another example scenario of conditional LTM in accordance with aspects of the present disclosure.

FIG. 8 illustrates another example scenario of conditional LTM in accordance with aspects of the present disclosure.

FIG. 9 illustrates another example scenario of conditional LTM in accordance with aspects of the present disclosure.

FIG. 10 illustrates an example MAC CE in accordance with aspects of the present disclosure.

FIG. 11 illustrates an example of a user equipment (UE) in accordance with aspects of the present disclosure.

FIG. 12 illustrates an example of a processor in accordance with aspects of the present disclosure.

FIG. 13 illustrates an example of a network equipment (NE) in accordance with aspects of the present disclosure.

FIG. 14 illustrates a flowchart of a method performed by a UE in accordance with aspects of the present disclosure.

FIG. 15 illustrates a flowchart of a method performed by a NE in accordance with aspects of the present disclosure.

### DETAILED DESCRIPTION

When a UE moves from the coverage area of one cell to another cell, at some point a serving cell change is performed due to the current serving cell not remaining a radio viable option. This serving cell change is also referred to as handover or cell handover. The serving cell change can be triggered by layer 3 (L3) measurements and done using RRC signaling triggered reconfiguration with synchronization for change of primary cell (PCell) and primary secondary cell (PSCell), as well as release/add for secondary cells (SCells) when applicable. Using higher layer (e.g., L3) signaling for handover involves complete layer 2 (L2) and layer 1 (L1), leading to longer latency, larger overhead, and longer interruption time than using lower layer (e.g., L1 or L2) signaling, also referred to as lower-layer triggered mobility (LTM). LTM is performed, for example, using a cell switch command that can be conveyed in a MAC CE, which contains the necessary information to perform the LTM cell switch.

Cell handover can be performed by using a conditional handover procedure where a handover is performed (also referred to as executed) by the UE when one or more conditions for at least one candidate cell are fulfilled. The UE is configured (e.g., by a gNB) with the one or more candidate cells and the one or more conditions, and performs the handover from the current serving cell to one of the candidate cells that satisfies the one or more conditions for the candidate cell.

TA is used to control the uplink transmission timing of UEs so that the uplink transmission from multiple UEs are synchronized when received at the NE (e.g., gNB). Generally, a UE that is further from the NE or has a large propagation delay has a larger TA than a UE that is closer to the NE or has a smaller propagation delay. The process of obtaining the TA is also referred to as TA acquisition or early TA acquisition.

When using a conditional handover procedure, one potential issue is that at the point of fulfilment of the one or more conditions for a first candidate cell, if the early TA acquisition with that candidate cell (requested by the network before receiving the cell switch command) has been completed (or not), e.g., if an early TA value is not yet available for the UE, is the UE to initiate a fresh RACH procedure towards the candidate cell. Another issue is if an early TA value is available for a first candidate cell for the UE but the one or more conditions for the first candidate cell are not yet fulfilled, how long is the UE to keep evaluating the first candidate cell while assuming the obtained TA is still valid. Another issue is which one or more candidate cells should the UE prioritize for handover execution if there are more than one candidate cells in a similar situation, e.g., for one candidate on a first frequency the TA validity is running out sooner but for the other on a second frequency the measurement result is promising, e.g., timer to trigger (TTT) for a measurement event condition might be fulfilled soon.

The techniques discussed herein address these issues with multiple scenarios based on timelines of where the one or more conditions (e.g., one or more measurement conditions) for at least one candidate cell is fulfilled (illustrated as point A in the figures) and early TA acquisition at the UE. The UE and network behavior to enable an efficient mobility and handover decision in these various scenarios is described.

In one or more implementations, the UE starts a timer (which may be referred to as a TA timer), which may have been configured earlier in a conditional configuration message (also referred to herein as a conditional reconfiguration message) received from the NE (e.g., gNB). If a TA value for a first candidate cell is received before the expiry of this timer, the UE transmits handover completion to the first candidate cell. However, if a TA value for the first candidate cell is received after the expiry of this timer, the UE considers the one or more conditions for the first candidate cell as not fulfilled and may invalidate the TA value and start a fresh evaluation or measurement of the one or more conditions.

The techniques discussed herein describe conditional handover using lower-layered signaling (e.g., L1 or L2). This allows for faster cell handover than can be performed using higher layer (e.g., L3) signaling. This also allows for the handover decision to be made by the UE rather than the gNB, improving efficiency and speed of the cell handover due to less communication between the UE and gNB in deciding when to perform the cell handover.

Aspects of the present disclosure are described in the context of a wireless communications system.

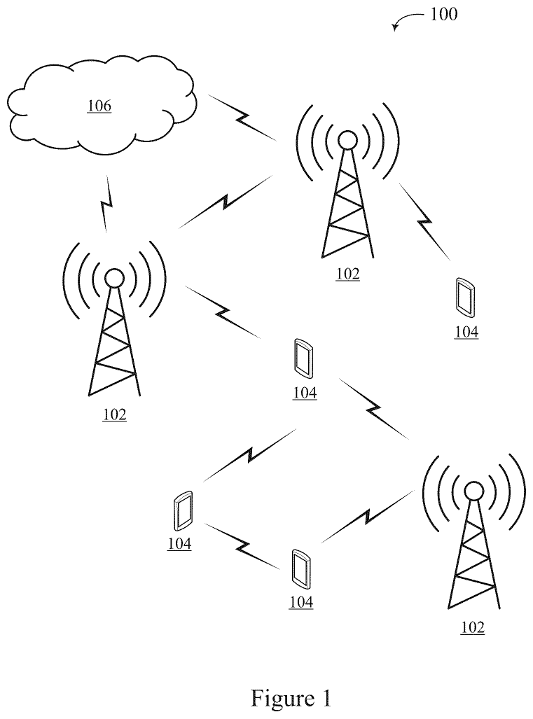

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some cases, a cell may refer to a radio access node in communication with a base station or including a base station. A cell may have a coverage area, which is a geographic area in which the cell may provide wireless connectivity to devices within. Different cells may operate on defined frequencies or frequency bands, referred to as subcarriers. In some examples, a UE 104 may establish a wireless connection with a cell, and subsequently that cell may be referred to as a serving cell or source cell of the UE 104.

In case of conditional handover procedure, a handover is executed by a UE 104 when one or more conditions for at least one candidate cell are fulfilled. Various scenarios for performing the conditional handover procedure based on timelines of when the one or more conditions for a candidate cell are fulfilled and early TA acquisition at the UE 104. This allows for efficient mobility of the UE and cell handover in these various scenarios.

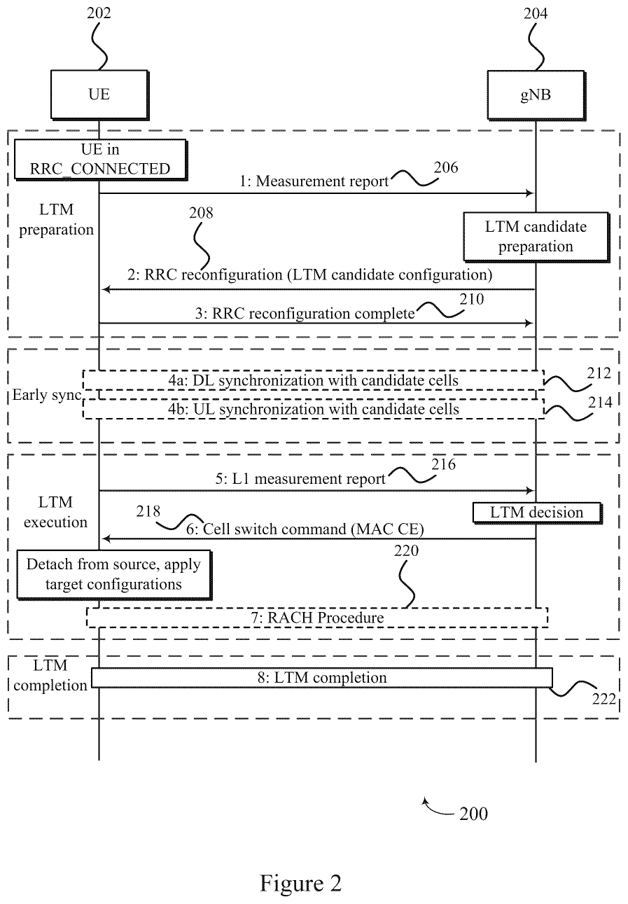

FIG. 2 illustrates an example LTM procedure 200 in accordance with aspects of the present disclosure. The LTM procedure shows an example signaling procedure for LTM between a UE 202 (e.g., a UE 104 of FIG. 1) and a gNB 204 (e.g., a NE 102 of FIG. 1). The example LTM procedure 200 illustrates cell handover where the decision to perform the cell handover is made by the gNB 204 rather than by the UE 202. Subsequent LTM is done by repeating the early synchronization (early sync), LTM execution, and LTM completion steps without releasing other LTM candidate cell configurations after each LTM completion.

At 206 (1: Measurement report), the UE 202 sends a MeasurementReport message to the gNB 204. The gNB 204 decides to configure LTM and initiates one or more candidate cells preparation.

At 208 (2: RRC reconfiguration), the gNB 204 transmits an RRCReconfiguration message to the UE 202 including the LTM candidate cell configurations of one or more candidate cells.

At 210 (3: RRC reconfiguration complete), the UE 202 stores the LTM candidate cell configurations and transmits an RRCReconfigurationComplete message to the gNB 204.

At 212 (4a: downlink (DL) synchronization with candidate cells), the UE 202 may perform DL synchronization with one or more candidate cells before receiving the cell switch command.

At 214 (4b: DL synchronization with candidate cells) the UE 202 may perform early TA acquisition with one or more candidate cells requested by the network before receiving the cell switch command. This is done via contention free random access (CFRA) triggered by a PDCCH order from the source cell, following which the UE 202 sends preamble towards the indicated candidate cell. In order to reduce the data interruption of the source cell due to CFRA towards the one or more candidate cells, the UE 202 does not receive random access response (RAR) for the purpose of TA value acquisition and the TA value of the candidate cell is indicated in the cell switch command. The UE 202 does not maintain the TA timer for the candidate cell and relies on network implementation to provide the TA validity.

At 216 (5: L1 measurement report), the UE 202 performs L1 measurements on the configured one or more candidate cells and transmits lower-layer measurement reports to the gNB 204. L1 measurement is performed as long as the RRC reconfiguration at 208 applies.

At 218 (6: Cell switch command), the gNB 204 decides to execute cell switch to a target cell and transmits a MAC CE triggering cell switch (LTM) by including the candidate configuration index of the target cell. The UE 202 switches to the target cell and applies the configuration indicated by candidate configuration index.

At 220 (7: RACH Procedure), the UE 202 performs the random access procedure towards the target cell, if UE 202 does not have valid TA of the target cell.

At 222 (8: LTM completion), the UE 202 completes the LTM cell switch procedure (by sending RRCReconfigurationComplete message to the target cell). If the UE 202 has performed a random access (RA) procedure at 220 the UE 202 considers that LTM execution is successfully completed when the random access procedure is successfully completed. For RACH-less LTM, the UE 202 considers that LTM execution is successfully completed when the UE 202 determines that the network has successfully received its first uplink (UL) data. The UE 202 determines successful reception of its first UL data by receiving a PDCCH addressing the UE's cell radio network temporary identifier (C-RNTI) in the target cell, which schedules a new transmission following the first UL data.

The actions at 212 through 222 can be performed multiple times for subsequent LTM cell switch using the one or more LTM candidate cell configurations provided at 208.

As an alternative to the RRC reconfiguration at 208, a conditional handover reconfiguration message can be used by the gNB 204 to transmit a message (e.g., RRCReconfiguration or a L2 MAC CE) to the UE including conditional LTM candidate cell configurations of one or multiple candidate cells. In such situations, measurement reports need not be transmitted to the gNB 204 at 216, and the gNB 204 need not decide to execute cell switch to a target cell nor transmit a MAC CE triggering cell switch (LTM) to the UE 202 at 218.

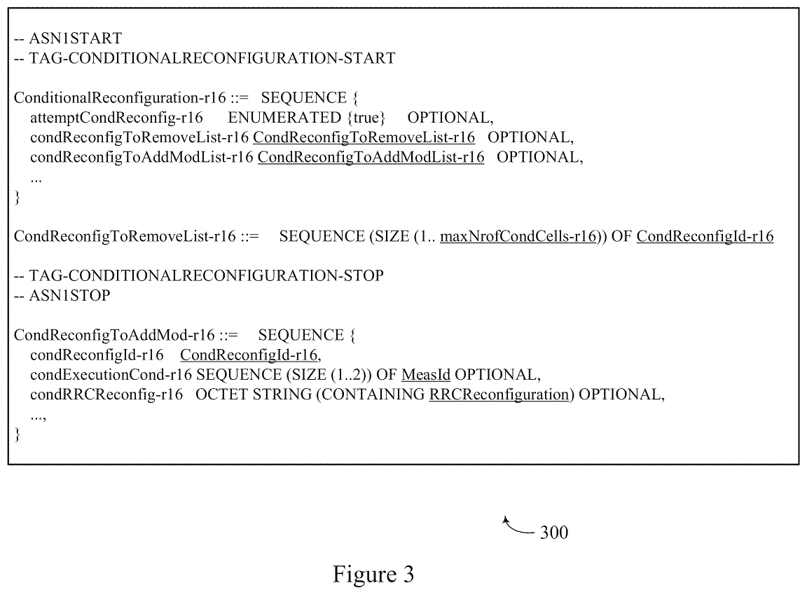

FIG. 3 illustrates an example of an RRC based conditional reconfiguration message 300 in accordance with aspects of the present disclosure. The RRC based conditional reconfiguration message 300 is an example message from the serving cell that contains handover candidates along with their conditions.

In one or more implementations, the network uses conditional LTM procedure for UEs and specific candidate cells for which a UE based TA may be calculated, a TA same as that of the source cell's current value (N_{TA}) can be assumed, or a TA value of 0 (N_{TA}) can be used. However, such cases may be limited and may not apply to UEs that cannot calculate UE-based TA or to bigger cells that would use a real TA determined based on a legacy procedure.

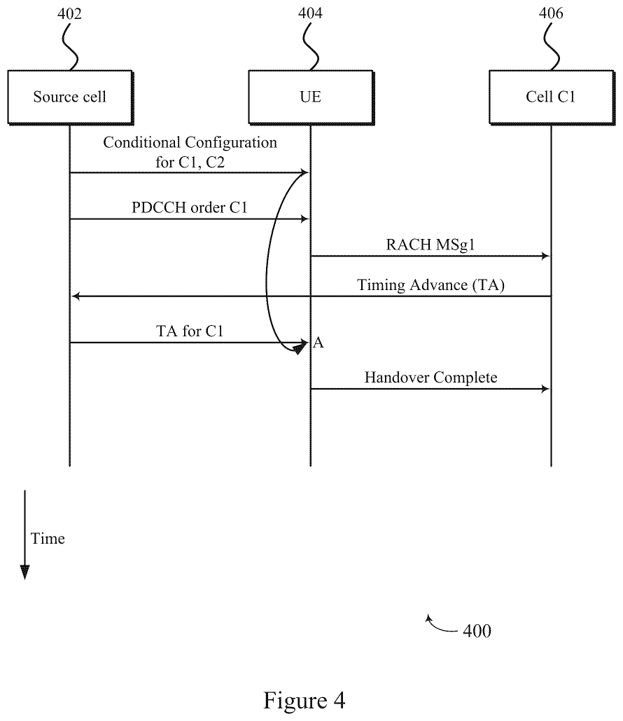

FIG. 4 illustrates an example scenario 400 of conditional LTM in accordance with aspects of the present disclosure. The scenario 400 illustrates a source cell 402 (also referred to as a serving cell or current serving cell), a UE 404, and a candidate cell 406. In the scenario 400 time flows from top to bottom. The source cell 402 transmits to the UE 404 a conditional configuration message for one or more candidate cells, illustrated as cell C1 and cell C2. The conditional configuration message includes one or more conditions, such as radio conditions, distance conditions, and so forth. The UE 404 monitors those conditions to determine if or when the conditions for one or more of the candidate cells are satisfied.

The source cell 402 transmits a PDCCH order for at least one of the candidate cells, illustrated as candidate cell 406 (cell C1). The PDCCH order indicates to the UE 404 to initiate an early TA procedure. The UE 404 transmits a RACH Message 1 (Msg1) to the candidate cell 406 that indicates to the candidate cell 406 to calculate the TA for the UE 404. The candidate cell 406 calculates the TA for the UE 404 and transmits the TA to the source cell 402. The source cell 402 transmits the TA for candidate cell 406 to the UE 404. The UE 404 determines that the one or more conditions for candidate cell 406 in the conditional configuration are satisfied, illustrated as point A in the example scenario 400. The UE 404 then transmits a handover complete message to the candidate cell 406.

In one or more implementations, the UE 404 starts condition evaluation immediately, as soon as possible based on the measurement gaps received in the configuration, of the one or more candidate cells. The one or more conditions for candidate cell 406 are fulfilled at point A, e.g., at the same time when the early TA for the candidate cell 406 is received from the source cell 402. Since handover (e.g., radio) condition fulfilment and early TA reception from the source cell are two independent events, and if this occurs the UE 404 transmits the handover completion to the candidate cell 406.

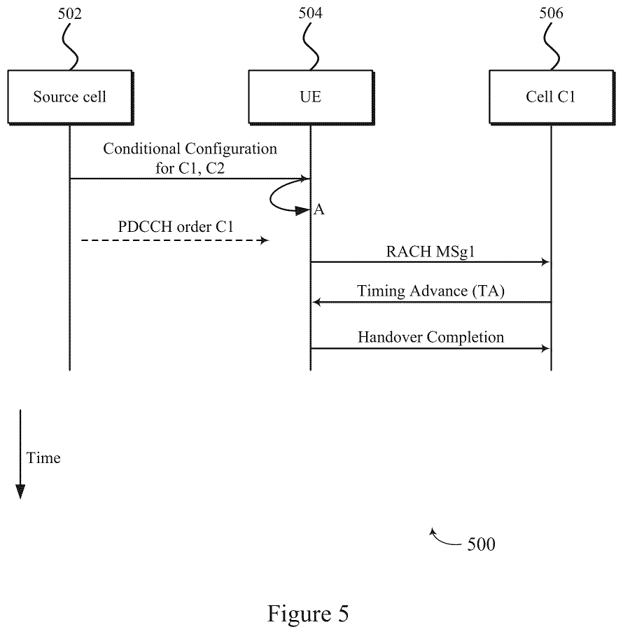

FIG. 5 illustrates another example scenario 500 of conditional LTM in accordance with aspects of the present disclosure. The scenario 500 illustrates a source cell 502 (also referred to as a serving cell or current serving cell), a UE 504, and a candidate cell 506 (cell C1). In the scenario 500 time flows from top to bottom. The source cell 502 transmits to the UE 504 a conditional configuration message for one or more candidate cells, illustrated as cell C1 and cell C2, that includes one or more conditions.

The UE 504 starts condition evaluation immediately, as soon as possible based on the measurement gaps received in the configuration, of one or more candidate cells. The one or more conditions for the candidate cell 506 are fulfilled at point A, e.g., before receiving a potential PDCCH Order for the candidate cell 506 to initiate early TA procedure.

In one or more implementations, the UE 504 starts handover procedure execution immediately after Point A. To this end, the UE 504 uses the PRACH resource indicated in the conditional configuration message, which may include a contention free PRACH resource. The RACH Msg1 transmission includes an implicit or explicit indication that the UE 504 is awaiting a timing advance in Msg2 and the same need not be sent to the source cell 502. This can be done implicitly by using the PRACH resource included for this purpose, if there are separate CFRA resources allocated for this purpose. Additionally or alternatively, this can be done explicitly using contention based random access (CBRA) resources, e.g., using the PRACH resources from SIB1 of the candidate cell 506. The message (Msg2) containing TA also includes UL resources for the UE 504 to transmit a handover completion to the cell C1, which can be a L3 reconfiguration complete message or a L2 MAC CE for the same purpose. UE can ignore a PDCCH order that may be received at a point later than the transmission of RACH Msg1.

In one or more implementations, the UE 504 starts handover procedure execution immediately after Point A after transmitting an indication (not shown in FIG. 5) to the source cell 502 that the UE 504 has started handover execution, information, e.g., indicating the target cell as C1 may also be included. This can be done by transmitting a L1 measurement report for cell C1, e.g., on physical uplink control channel (PUCCH) channel or physical uplink shared channel (PUSCH) resources, if available. Additionally or alternatively, a L3 measurement reporting can be also used for this purpose.

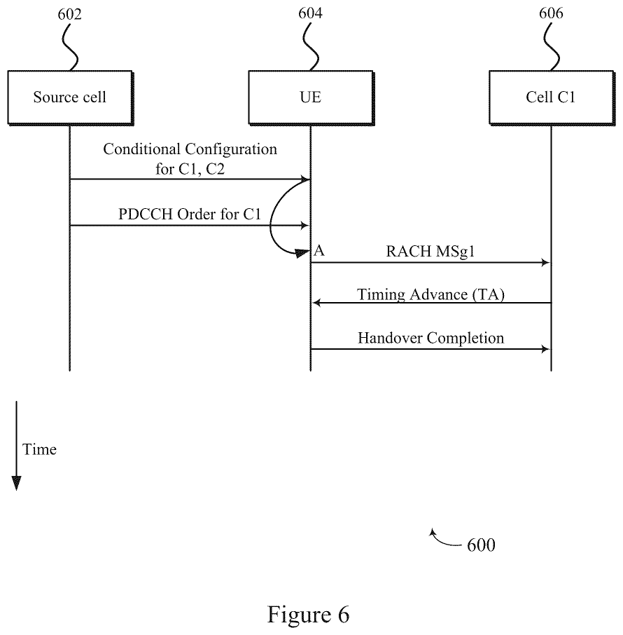

FIG. 6 illustrates another example scenario 600 of conditional LTM in accordance with aspects of the present disclosure. The scenario 600 illustrates a source cell 602 (also referred to as a serving cell or current serving cell), a UE 604, and a candidate cell 606 (cell C1). In the scenario 600 time flows from top to bottom. The source cell 602 transmits to the UE 604 a conditional configuration message for one or more candidate cells, illustrated as cell C1 and cell C2, that includes one or more conditions.

The UE 604 starts condition evaluation immediately, as soon as possible based on the measurement gaps received in the configuration, of one or more candidate cells. The one or more conditions for candidate cell 606 are fulfilled at point A, e.g., after receiving a potential PDCCH order for the same cell to initiate early TA procedure but the RACH Msg1 has not been transmitted yet.

In one or more implementations, the UE 604 starts handover procedure execution immediately after Point A. To this end, the UE 604 uses the PRACH resource indicated in the conditional configuration message, which may include a contention free PRACH resource. The RACH Msg1 transmission includes an implicit or explicit indication that the UE 604 is awaiting a timing advance in Msg2 and the same need not be sent to the source cell 602. This can be done implicitly by using the PRACH resource included for this purpose, if there are separate CFRA resources allocated for this purpose. Additionally or alternatively, this can be done explicitly using CBRA resources, e.g., using the PRACH resources from SIB1 of the candidate cell 606. The message (Msg2) containing TA also includes UL resources for the UE 604 to transmit a handover completion to the cell C1, which can be a L3 reconfiguration complete message or a L2 MAC CE for the same purpose.

In one or more implementations, the UE 604 starts handover procedure execution immediately after Point A after transmitting an indication (not shown in FIG. 6) to the source cell 602 that the UE 604 has started handover execution, information, e.g., indicating the target cell as C1 may also be included. This can be done by transmitting a L1 measurement report for cell C1, e.g., on PUCCH channel or PUSCH resources, if available. Additionally or alternatively, a L3 measurement reporting can be also used for this purpose.

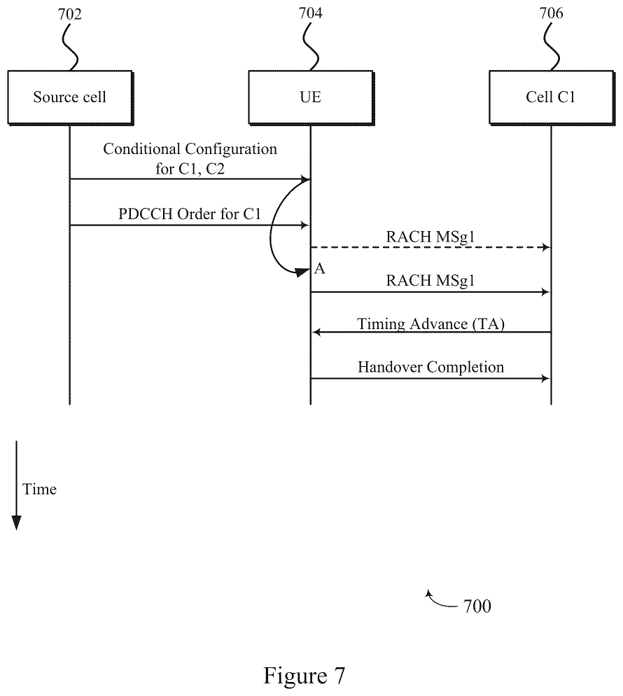

FIG. 7 illustrates another example scenario 700 of conditional LTM in accordance with aspects of the present disclosure. The scenario 700 illustrates a source cell 702 (also referred to as a serving cell or current serving cell), a UE 704, and a candidate cell 706 (cell C1). In the scenario 700 time flows from top to bottom. The source cell 702 transmits to the UE 704 a conditional configuration message for one or more candidate cells, illustrated as cell C1 and cell C2, that includes one or more conditions.

The UE 704 starts condition evaluation immediately, as soon as possible based on the measurement gaps received in the configuration, of one or more candidate cells. The one or more conditions for candidate cell 706 are fulfilled at point A, e.g., after receiving a potential PDCCH Order for the same cell to initiate early TA procedure, and the RACH Msg1 may have been transmitted already.

In one or more implementations, the UE 704 starts handover procedure execution immediately after Point A. To this end, the UE 704 uses (or reuses) the PRACH resource indicated in the conditional configuration message irrespective of if a Msg1 transmission to the candidate cell 706 has been made already. Previously received configuration may include contention free PRACH resources. The RACH Msg1 transmission includes an implicit or explicit indication that the UE 704 is awaiting a timing advance in Msg2 and the same need not be sent to the source cell 702. This can be done implicitly by using the PRACH resource included for this purpose, if there are separate CFRA resources allocated for this purpose. Additionally or alternatively, this can be done explicitly using CBRA resources, e.g., using the PRACH resources from SIB1 of the candidate cell 706. The message (Msg2) containing TA also includes UL resources for the UE 704 to transmit a handover completion to the cell C1, which can be a L3 reconfiguration complete message or a L2 MAC CE for the same purpose.

If the UE 704 used a CBRA based resource to transmit Msg1 but a TA for the candidate cell 706 has been received from the source cell (e.g., as shown in FIG. 4 above), before receiving TA directly from the candidate cell 706 target as shown in FIG. 7, the UE 704 uses the received early TA and configured grant that may have been included in the conditional configuration message to transmit handover complete message to the candidate cell 706.

In one or more implementations, the UE 704 starts handover procedure execution immediately after Point A after transmitting an indication (not shown in FIG. 7) to the source cell 702 that the UE 704 has started handover execution, information, e.g., indicating the target cell as C1 may also be included. This can be done by transmitting a L1 measurement report for cell C1, e.g., on PUCCH channel or PUSCH resources, if available. Additionally or alternatively, a L3 measurement reporting can be also used for this purpose.

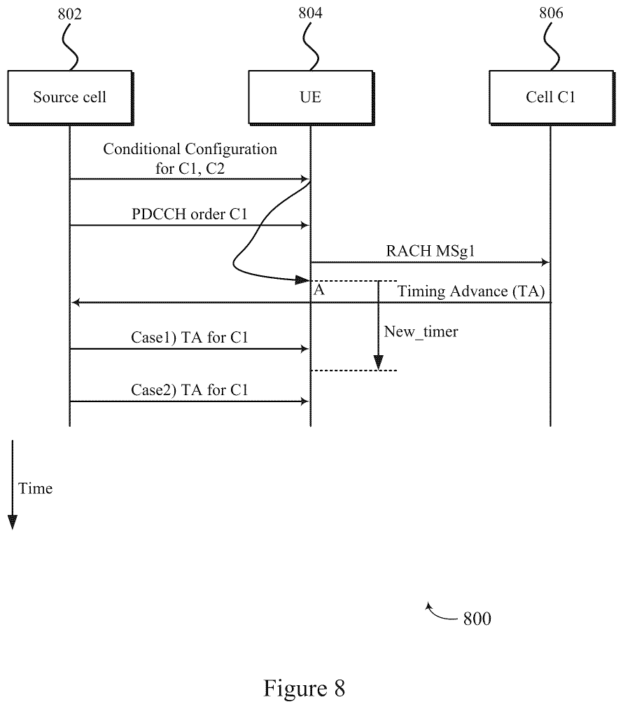

FIG. 8 illustrates another example scenario 800 of conditional LTM in accordance with aspects of the present disclosure. The scenario 800 illustrates a source cell 802 (also referred to as a serving cell or current serving cell), a UE 804, and a candidate cell 806 (cell C1). In the scenario 800 time flows from top to bottom. The source cell 802 transmits to the UE 804 a conditional configuration message for one or more candidate cells, illustrated as cell C1 and cell C2, that includes one or more conditions.

The UE 804 starts condition evaluation immediately, as soon as possible based on the measurement gaps received in the configuration, of one or more candidate cells. The one or more conditions for candidate cell 806 are fulfilled at point A, e.g., after receiving a potential PDCCH Order for the same cell to initiate early TA procedure, and after the RACH Msg1 transmission but a TA for the candidate cell 806 has not yet been received from the source cell 802.

The UE 804 starts a timer (e.g., New_timer) at point A. The timer (e.g., the duration of the timer) is optionally configured earlier in the conditional configuration message. If a TA for the candidate cell 806 is received before the expiry of this timer (case1 in the example scenario 800), the UE 804 transmits handover completion as discussed above with reference to FIG. 4. If a TA for the candidate cell 806 is received after the expiry of this timer (case2 in the example scenario 800), the UE 804 considers the conditions for C1 as not fulfilled anymore (e.g., invalidates the TA value) and may start a fresh evaluation or measurement of the one or more conditions.

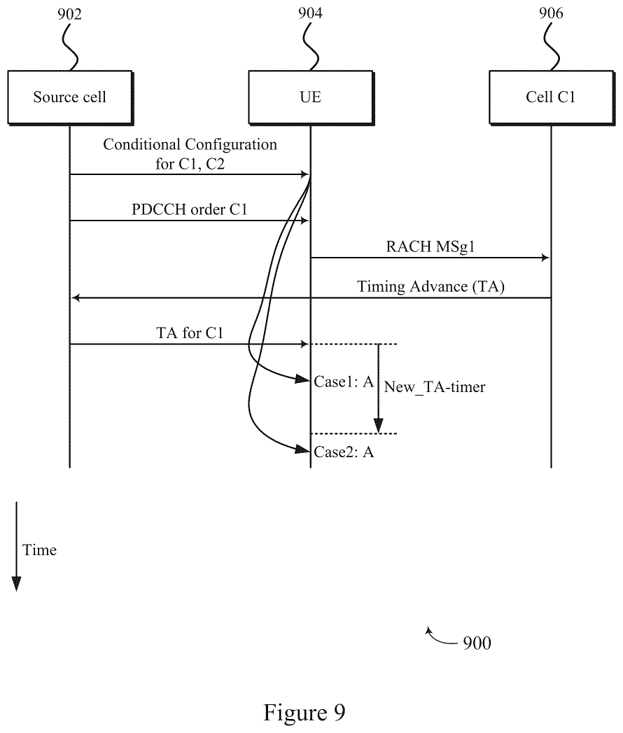

FIG. 9 illustrates another example scenario 900 of conditional LTM in accordance with aspects of the present disclosure. The scenario 900 illustrates a source cell 902 (also referred to as a serving cell or current serving cell), a UE 904, and a candidate cell 906 (cell C1). In the scenario 900 time flows from top to bottom. The source cell 902 transmits to the UE 904 a conditional configuration message for one or more candidate cells, illustrated as cell C1 and cell C2, that includes one or more conditions.

The UE 904 starts condition evaluation immediately, as soon as possible based on the measurement gaps received in the configuration, of one or more candidate cells. The one or more conditions for candidate cell 906 are fulfilled at point A, e.g., after receiving a TA for the candidate cell 906 from the source cell but at which point it is unclear if the TA for the candidate cell 906 is still valid.

In one or more implementations, the UE 904 transmits handover completion as discussed above with reference to FIG. 4 using the timing advance value last received, without any further consideration for its validity e.g., behaving as if the TA value would otherwise have been received in the early TA procedure for LTM mobility.

Additionally or alternatively, the UE 904 starts a timer (e.g., New_TA-timer) when TA for the candidate cell 906 is received. The timer (e.g., the duration of the timer) is optionally configured earlier in the conditional configuration message, or included in the same message that includes TA for C1.

If Point A occurs before the expiry of this timer (Case1 in the example scenario 900), the UE 904 transmits handover completion as discussed above with reference to FIG. 4. If Point A occurs after the expiry of this timer (Case2 in the example scenario 900), the UE 904 starts handover procedure execution immediately after Point A. To this end, the UE 904 uses or reuses the PRACH resource indicated in the conditional configuration message irrespective of if a Msg1 transmission to the candidate cell 906 has been made already. A previously received configuration may include contention free PRACH resources. The RACH Msg1 transmission includes an implicit or explicit indication that the UE 904 is awaiting a timing advance in Msg2 and the same need not be sent to the source cell 902. This can be done implicitly by using the PRACH resource included for this purpose, if there are separate CFRA resources allocated for this purpose. Additionally or alternatively, this can be done explicitly using CBRA resources, e.g., using the PRACH resources from SIB1 of the candidate cell 906. The message (Msg2) containing TA also includes UL resources for the UE 904 to transmit a handover completion to the cell C1, which can be a L3 reconfiguration complete message or a L2 MAC CE for the same purpose.

The TA for C1 can be provided using a reserved bit in the “LTM Cell Switch Command MAC CE”, described in 3rd Generation Partnership Project (3GPP) technical specification (TS) 38.321-100.

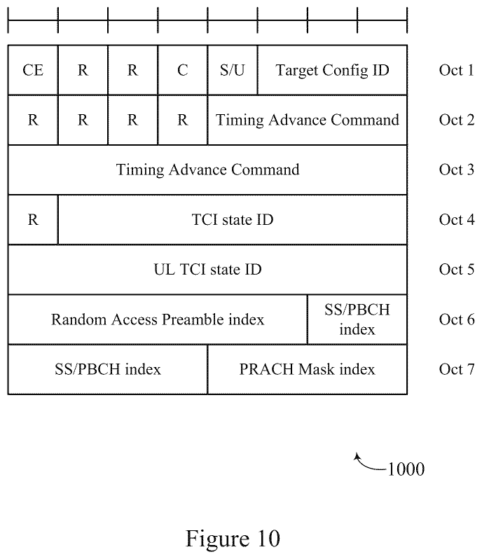

FIG. 10 illustrates an example MAC CE 1000 in accordance with aspects of the present disclosure. The MAC CE 1000 is an LTM cell switch command MAC CE. The LTM cell switch command MAC CE is identified by MAC subheader with extended logical channel ID (eLCID) as specified in the MAC CE 1000. The MAC CE 1000 has a variable size with the following fields.

A CE field. When set to 1, the UE executes handover conditionally; else the UE executes handover to the included target immediately.

An R field. Reserved bit, set to 0.

A Target Configuration ID field. This field indicates the index of candidate target configuration to apply for LTM cell switch, corresponding to Itm-CandidateId minus 1 as specified in 3GPP TS 38.331. The length of the field is 3 bits.

A Timing Advance Command field. This field indicates whether the TA is valid for the LTM target cell (e.g., the SpCell corresponding to the target configuration indicated by Target Configuration ID field). If the value of this field is set to FFF, this field indicates that no valid timing adjustment is available for the primary timing advance group (PTAG) of the LTM target cell; Otherwise, this field indicates the index value T_{A} used to control the amount of timing adjustment that the MAC entity has to apply in 3GPP TS 38.213, and that the UE can skip the Random Access procedure for this LTM cell switch. The length of the field is 12 bits.

A transmission configuration indicator (TCI) state ID. This field indicates and activates the TCI state for the LTM target cell (e.g., the SpCell of the target configuration indicated by the Target Configuration ID field). The TCI state is identified by TCI-StateId in Itm-DL-OrJointTCI-StateToAddModList as specified in 3GPP TS 38.331. If the value of unifiedTCI-StateType in the configuration indicated by Target Configuration ID field is joint, this field is for joint TCI state, otherwise, this field is for downlink TCI state. The length of the field is 7 bits.

A UL TCI state ID. This field indicates and activates the uplink TCI state for the LTM target cell (e.g., the SpCell of the target configuration indicated by the Target Configuration ID field). The most significant bits of UL TCI state ID are considered as reserved bits and the remainder 6 bits indicate the TCI-UL-StateId in Itm-UL-TCI-StatesToAddModList as specified in 3GPP TS 38.331. This field is included if the value of unifiedTCI-StateType in the configuration indicated by Target Configuration ID field is separate. The length of the field is 8 bits.

A C field. This field indicates the presence of the contention-free Random Access Resources fields. If the value of this field is set to 1, the following fields are present, including Random Access Preamble index field, S/U field, synchronization signal (SS)/physical broadcast channel (PBCH) index field and PRACH Mask index field. If the value of this field is set to 0, Random Access Preamble index field, SS/PBCH index field and PRACH Mask index field are absent, and S/U field is considered as Reserved field.

An S/U field. This field indicates which UL carrier to transmit the PRACH of the contention-free Random Access Resources. If the value of this field is set to 1, supplementary uplink (SUL) is used; otherwise, NUL is used. The length of the field is 1 bit.

A Random Access Preamble index field. This field indicates the Random Access Preamble index of the contention-free Random Access Resources. The length of the field is 6 bits.

An SS/PBCH index field. This field indicates the SS/PBCH that shall be used to determine the RACH occasion for the PRACH transmission of the contention-free Random Access Resources. The length of the field is 6 bits.

A PRACH Mask index field: This field indicates the RACH occasion(s) associated with the SS/PBCH indicated by “SS/PBCH index” for the PRACH transmission of the contention-free Random Access Resources, referring to the rach-ConfigDedicated (if not provided otherwise to the rach-ConfigCommon) in the UL bandwidth part (BWP) configuration of firstActiveUplinkBWP-Id as specified in 3GPP TS 38.331. The length of the field is 4 bits.

As an alternate to re-purposing the LTM cell switch command MAC CE, a new MAC CE can be used with similar contents described but with another reserved logical channel ID (LCID).

In one or more implementations, the source cell includes prioritization (e.g., order or sequence) of candidate cells or their frequencies in the conditional reconfiguration message and the UE starts the measurement or measurement evaluation in sequence as suggested by the network, starting with the first included candidate cell or frequency. Further procedure runs as discussed above, depending on which scenario occurs, e.g., with regards to early TA reception and Point A occurrence.

In one or more implementations, the UE prioritizes candidates for handover execution if there are more than one candidate cells in similar situation, e.g., for one candidate on a first frequency the TA validity is running out sooner but for the other on a second frequency the measurement result is promising, e.g., TTT for a measurement event condition might be fulfilled soon.

In one example, the prioritization is based on prioritization (e.g., order or sequence) of candidate cells or their frequencies in the received conditional reconfiguration message.

In another example, the UE prioritizes a candidate for handover execution that has reached or met Point A earlier (or later).

In another example, the UE prioritizes a candidate for handover execution for which a TA or an early TA has been received most recently.

It should be noted that the discussions above also apply to the case when the UE estimates its own TA based on UE based techniques (e.g., based on DL timing difference of source and candidate cell) with the difference that TA for C1 is not received from the source cell but is determined by the UE and the applicable time (instead of time at which TA for C1 is received, such as show in FIG. 4) is the time when the UE has successfully determined TA for a candidate cell.

Multiple scenarios described herein are based on timelines of Point A (where the one or more measurement conditions for at least one candidate cell are fulfilled) and (early) TA acquisition at the UE. The UE and network behavior to enable efficient mobility decision in these situations indicate:
(1) Both RRC based and L2 based conditional reconfiguration are possible.
(2) UE initiates RACH procedure for a conditional LTM candidate if an early TA has not been received at point A. This includes indication for the target cell to determine that UL TA (N_{TA}) is transmitted to the UE in RACH Msg2 (and not to the source cell). Msg1 resources for the indication may have been provided to the UE from the one or more candidate cells. When not provided, the UE starts a CBRA procedure. The RACH procedure may be initiated even if the PDCCH Order based Msg1 transmission has already occurred, but an early TA has not been received yet.
(3) A new (e.g., configurable) timer to check the validity of Point A is discussed, which can be configured or used if the UE expects the source to transmit TA for a candidate cell anytime (and PDCCH Order based Msg1 transmission has already occurred). If timer expires, the UE considers the one or more measurement conditions for the candidate cell in question as not fulfilled anymore. Fresh measurement or measurement evaluation may be initiated.
(4) Similarly, a new (e.g., configurable) TA-timer to check the validity of determined or received (early) TA is discussed, this can be configured or used if the UE expects that the corresponding candidate cell might fulfil the handover execution condition soon. A handover is executed only if the TA-timer is running, at expiry the TA is not considered valid anymore.

The source cell may include prioritization (e.g., order or sequence) of candidate cells or their frequencies in the conditional reconfiguration message.

The UE prioritizes candidates for handover execution if there are more than one candidate cells in similar situation, e.g., for one candidate on a first frequency the TA validity is running out sooner but for the other on a second frequency the measurement result is promising. This prioritization can be based on prioritization (e.g., order or sequence) of candidate cells in the reconfiguration message. This prioritization can be to prioritize a candidate that has reached or met Point A earlier. This prioritization can be to prioritize a candidate for which a TA or an early TA has been received most recently.

The TA may be an early TA or UE estimates its own TA based on UE based techniques (e.g., based on DL timing difference of source and candidate cell).

In a straight forward implementation, the network may use conditional LTM procedure only for UEs and specific candidate cell(s) for which a UE based TA may be calculated, or a TA same as that of the source cell's current value (N_{TA}) can be assumed, a TA value of 0 (N_{TA}) can be used. However, such cases may be limited and may not apply to UEs that cannot calculate UE based TA or to bigger cells that would use a real TA determined based on legacy procedure.

In one or more implementations, the UE starts a new_timer, which may have been configured earlier in the conditional configuration message at point A. If a TA for C1 is received before the expiry of this timer, the UE transmits handover completion. If a TA for C1 is received after the expiry of this timer, the UE considers the conditions for C1 as not fulfilled anymore and may start a fresh evaluation or measurement.

Additionally or alternatively, the UE prioritizes candidates for handover execution if there are more than one candidate cells in similar situation, e.g., for one candidate on a first frequency the TA validity is running out sooner but for the other on a second frequency the measurement result is promising, e.g., TTT for a measurement event condition might be fulfilled soon. In one example, the prioritization is based on prioritization (e.g., order or sequence) of candidate cells or their frequencies in the received conditional reconfiguration message. Additionally or alternatively, the UE prioritizes a candidate for handover execution that has reached or met Point A earlier. Additionally or alternatively, the UE prioritizes a candidate for handover execution for which a TA or an early TA has been received most recently.

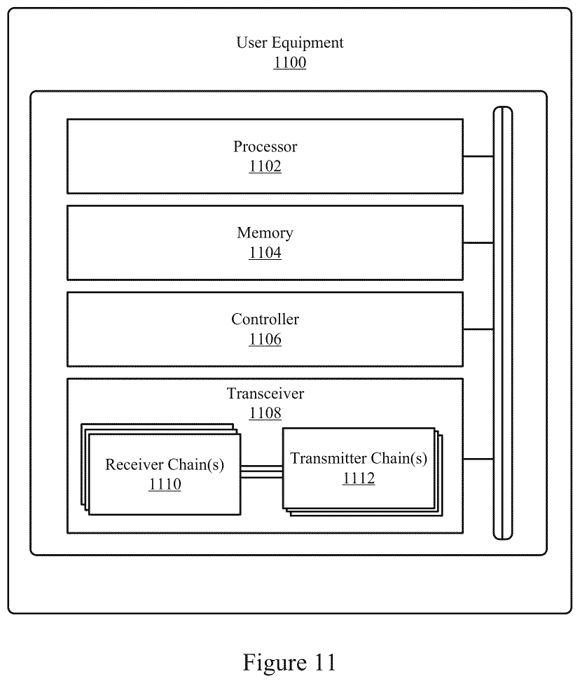

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the functions described herein (e.g., executing, by the processor 1102, instructions stored in the memory 1104). For example, the processor 1102 may support wireless communication at the UE 1100 in accordance with examples as disclosed herein. The UE 1100 may be configured to or operable to support a means for receiving, from a serving cell, a first signaling that indicates one or more PRACH resources and one or more execution conditions for at least one candidate cell; receiving, from the serving cell, a second signaling that indicates to the UE to initiate an early TA procedure for a first candidate cell of the at least one candidate cell; starting a timer; and transmitting, to the first candidate cell, a third signaling that includes a handover complete message if a TA value is received prior to expiration of the timer and the one or more execution conditions for the first candidate cell are satisfied, or invalidate the TA value if the TA value is received after the timer expires.

Additionally, the UE 1100 may be configured to support any one or combination of where the first signaling indicates a duration of the timer; where the first signaling comprises a layer 3 RRC reconfiguration message; where the handover complete message comprises a layer 3 RRC Reconfiguration complete message; transmitting, to the first candidate cell, a fourth signaling that includes a RACH message 1; receiving, from the serving cell, a fifth signaling that includes the TA value for the first candidate cell; where the fifth signaling comprises a lower layer MAC CE; where the MAC CE includes an identification of the first candidate cell including a target frequency and cell identity, a physical beam indication, the timing advance, or a combination thereof for transmitting the third signaling; starting the timer in response to the one or more execution conditions for the first candidate cell being satisfied; evaluating measurements of one or more signals received from the at least one cell; and determining, based on the measurements, whether the one or more execution conditions for the at least one cell are satisfied; where the second signaling comprises a PDCCH order; starting the timer in response to receiving the TA value from the serving cell; where the at least one candidate cell comprises multiple candidate cells; prioritizing the multiple candidate cells according to one or more criteria; and selecting, as the first candidate cell, one of the multiple candidate cells having a highest priority; where the one or more criteria include an order or sequence of the multiple candidate cells or frequencies of the multiple candidate cells; where the one or more criteria include a time of when, for each of the multiple candidate cells, the one or more execution conditions for the candidate cell are satisfied; where the one or more criteria include a time of when, for each of the multiple candidate cells, the TA for the candidate cell is received.

Additionally, or alternatively, the UE 1100 may support at least one memory (e.g., the memory 1104) and at least one processor (e.g., the processor 1102) coupled with the at least one memory and configured to cause the UE to: receive, from a serving cell, a first signaling that indicates one or more PRACH resources and one or more execution conditions for at least one candidate cell; receive, from the serving cell, a second signaling that indicates to the UE to initiate an early TA procedure for a first candidate cell of the at least one candidate cell; start a timer; and transmit, to the first candidate cell, a third signaling that includes a handover complete message if a TA value is received prior to expiration of the timer and the one or more execution conditions for the first candidate cell are satisfied, or invalidate the TA value if the TA value is received after the timer expires.

Additionally, the UE 1100 may be configured to support any one or combination of the at least one processor is configured to where the first signaling indicates a duration of the timer; where the first signaling comprises a layer 3 RRC reconfiguration message; where the handover complete message comprises a layer 3 RRC Reconfiguration complete message; transmit, to the first candidate cell, a fourth signaling that includes a RACH message 1; and receive, from the serving cell, a fifth signaling that includes the TA value for the first candidate cell; where the fifth signaling comprises a lower layer MAC CE; where the MAC CE includes an identification of the first candidate cell including a target frequency and cell identity, a physical beam indication, the timing advance, or a combination thereof for transmitting the third signaling; start the timer in response to the one or more execution conditions for the first candidate cell being satisfied; evaluate measurements of one or more signals received from the at least one cell; and determine, based on the measurements, whether the one or more execution conditions for the at least one cell are satisfied; where the second signaling comprises a PDCCH order; start the timer in response to receiving the TA value from the serving cell.; where the at least one candidate cell comprises multiple candidate cells; prioritize the multiple candidate cells according to one or more criteria; and select, as the first candidate cell, one of the multiple candidate cells having a highest priority; where the one or more criteria include an order or sequence of the multiple candidate cells or frequencies of the multiple candidate cells; where the one or more criteria include a time of when, for each of the multiple candidate cells, the one or more execution conditions for the candidate cell are satisfied; where the one or more criteria include a time of when, for each of the multiple candidate cells, the TA for the candidate cell is received.

The controller 1106 may manage input and output signals for the UE 1100. The controller 1106 may also manage peripherals not integrated into the UE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

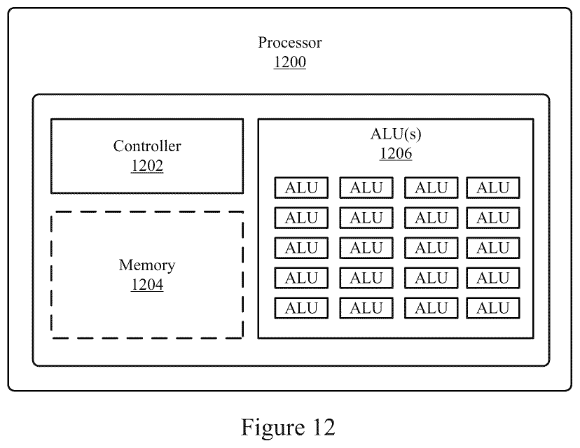

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory addresses of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, ALUs 1206, and other functional units of the processor 1200.

The memory 1204 may include one or more caches (e.g., memory local to or included in the processor 1200 or other memory, such as RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, and the controller 1202, and may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 may be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to or operable to support at least one controller (e.g., the controller 1202) coupled with at least one memory (e.g., the memory 1204) and configured to cause the processor to: receive, from a serving cell, a first signaling that indicates one or more PRACH resources and one or more execution conditions for at least one candidate cell; receive, from the serving cell, a second signaling that indicates to the processor to initiate an early TA procedure for a first candidate cell of the at least one candidate cell; start a timer; and transmit, to the first candidate cell, a third signaling that includes a handover complete message if a TA value is received prior to expiration of the timer and the one or more execution conditions for the first candidate cell are satisfied, or invalidate the TA value if the TA value is received after the timer expires.

Additionally, the processor 1200 may be configured to or operable to support any one or combination of the at least one controller is configured to cause the processor to where the first signaling indicates a duration of the timer; where the first signaling comprises a layer 3 RRC reconfiguration message; where the handover complete message comprises a layer 3 RRC Reconfiguration complete message; transmit, to the first candidate cell, a fourth signaling that includes a RACH message 1; and receive, from the serving cell, a fifth signaling that includes the TA value for the first candidate cell; where the fifth signaling comprises a lower layer MAC CE; where the MAC CE includes an identification of the first candidate cell including a target frequency and cell identity, a physical beam indication, the timing advance, or a combination thereof for transmitting the third signaling; start the timer in response to the one or more execution conditions for the first candidate cell being satisfied; evaluate measurements of one or more signals received from the at least one cell; and determine, based on the measurements, whether the one or more execution conditions for the at least one cell are satisfied; where the second signaling comprises a PDCCH order; start the timer in response to receiving the TA value from the serving cell; where the at least one candidate cell comprises multiple candidate cells, and prioritize the multiple candidate cells according to one or more criteria; and select, as the first candidate cell, one of the multiple candidate cells having a highest priority; where the one or more criteria include an order or sequence of the multiple candidate cells or frequencies of the multiple candidate cells; where the one or more criteria include a time of when, for each of the multiple candidate cells, the one or more execution conditions for the candidate cell are satisfied; where the one or more criteria include a time of when, for each of the multiple candidate cells, the TA for the candidate cell is received.

The processor 1200 may be configured to or operable to support at least one controller (e.g., the controller 1202) coupled with at least one memory (e.g., the memory 1204) and configured to cause the processor to: transmit, to a UE, a first signaling that indicates a conditional configuration for at least one candidate cell including a timer, one or more PRACH resources, and one or more execution conditions for the at least one candidate cell; transmit, to the UE, a second signaling that indicates to the UE to initiate an early TA procedure for a first candidate cell of the at least one candidate cell; receive, from the first candidate cell of the at least one candidate cell, a third signaling indicating a TA value; and transmit, to the UE, a fourth signaling indicating the received TA value.

Additionally, the processor 1200 may be configured to or operable to support any one or combination of the at least one controller is configured to cause the processor to where the first signaling indicates a duration of the timer; where the first signaling comprises a layer 3 RRC reconfiguration message; where the fourth signaling comprises a lower layer MAC CE; where the MAC CE includes an identification of the first candidate cell including a target frequency and cell identity, a physical beam indication, the TA, or a combination thereof; where the second signaling comprises a PDCCH order.

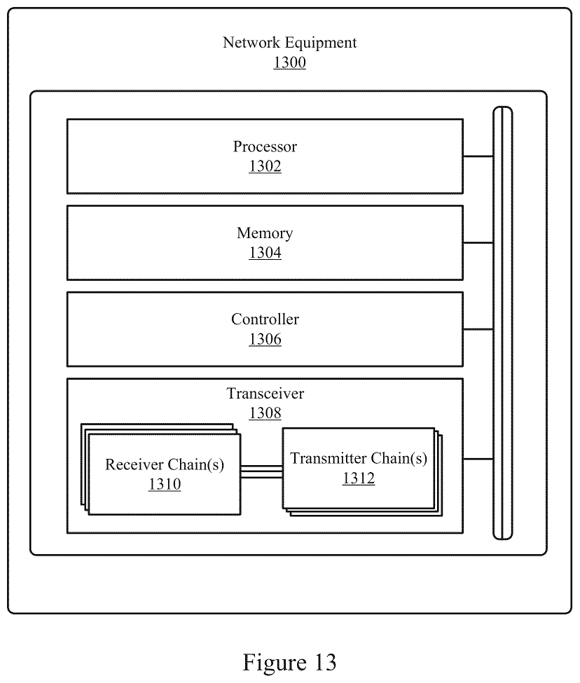

FIG. 13 illustrates an example of a NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein. The NE 1300 may be configured to support a means for transmitting, to a UE, a first signaling that indicates a conditional configuration for at least one candidate cell including a timer, one or more PRACH resources, and one or more execution conditions for the at least one candidate cell; transmitting, to the UE, a second signaling that indicates to the UE to initiate an early TA procedure for a first candidate cell of the at least one candidate cell; receiving, from the first candidate cell of the at least one candidate cell, a third signaling indicating a TA value; and transmitting, to the UE, a fourth signaling indicating the received TA value.

Additionally, the NE 1300 may be configured to support any one or combination of where the first signaling indicates a duration of the timer; where the first signaling comprises a layer 3 RRC reconfiguration message; the fourth signaling comprises a lower layer MAC CE; where the MAC CE includes an identification of the first candidate cell including a target frequency and cell identity, a physical beam indication, the TA, or a combination thereof; where the second signaling comprises a PDCCH order.

Additionally, or alternatively, the NE 1300 may support at least one memory (e.g., the memory 1304) and at least one processor (e.g., the processor 1302) coupled with the at least one memory and configured to cause the NE to: transmit, to a UE, a first signaling that indicates a conditional configuration for at least one candidate cell including a timer, one or more PRACH resources, and one or more execution conditions for the at least one candidate cell; transmit, to the UE, a second signaling that indicates to the UE to initiate an early TA procedure for a first candidate cell of the at least one candidate cell; receive, from the first candidate cell of the at least one candidate cell, a third signaling indicating a TA value; and transmit, to the UE, a fourth signaling indicating the received TA value.

Additionally, the NE 1300 may be configured to support any one or combination of the at least one processor is configured to cause the NE to where the first signaling indicates a duration of the timer; where the first signaling comprises a layer 3 RRC reconfiguration message; where the fourth signaling comprises a lower layer MAC CE; where the MAC CE includes an identification of the first candidate cell including a target frequency and cell identity, a physical beam indication, the TA, or a combination thereof; where the second signaling comprises a PDCCH order.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

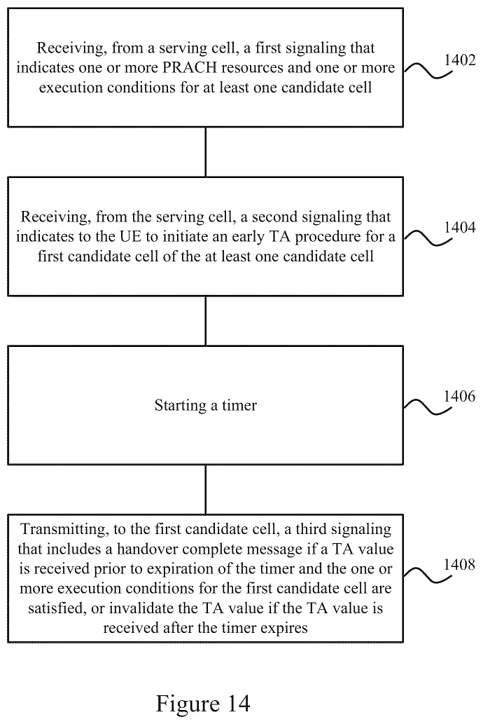

FIG. 14 illustrates a flowchart of a method in accordance with aspects of the present disclosure. The operations of the method may be implemented by a UE as described herein. In some implementations, the UE may execute a set of instructions to control the function elements of the UE to perform the described functions.

At 1402, the method may include receiving, from a serving cell, a first signaling that indicates one or more PRACH resources and one or more execution conditions for at least one candidate cell. The operations of 1402 may be performed in accordance with examples as described herein. In some implementations, aspects of the operations of 1402 may be performed by a UE as described with reference to FIG. 11.

At 1404, the method may include receiving, from the serving cell, a second signaling that indicates to the UE to initiate an early TA procedure for a first candidate cell of the at least one candidate cell. The operations of 1404 may be performed in accordance with examples as described herein. In some implementations, aspects of the operations of 1404 may be performed by a UE as described with reference to FIG. 11.

At 1406, the method may include starting a timer. The operations of 1406 may be performed in accordance with examples as described herein. In some implementations, aspects of the operations of 1406 may be performed a UE as described with reference to FIG. 11.

At 1408, the method may include transmitting, to the first candidate cell, a third signaling that includes a handover complete message if a TA value is received prior to expiration of the timer and the one or more execution conditions for the first candidate cell are satisfied, or invalidate the TA value if the TA value is received after the timer expires. The operations of 1408 may be performed in accordance with examples as described herein. In some implementations, aspects of the operations of 1408 may be performed a UE as described with reference to FIG. 11.

It should be noted that the method described herein describes a possible implementation, and that the operations and the steps may be rearranged or otherwise modified and that other implementations are possible.

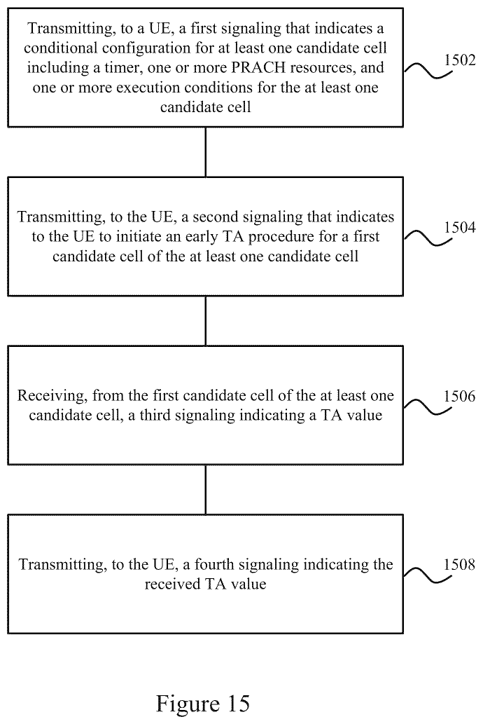

FIG. 15 illustrates a flowchart of a method in accordance with aspects of the present disclosure. The operations of the method may be implemented by a NE as described herein. In some implementations, the NE may execute a set of instructions to control the function elements of the NE to perform the described functions.

At 1502, the method may include transmitting, to a UE, a first signaling that indicates a conditional configuration for at least one candidate cell including a timer, one or more PRACH resources, and one or more execution conditions for the at least one candidate cell. The operations of 1502 may be performed in accordance with examples as described herein. In some implementations, aspects of the operations of 1502 may be performed by a NE as described with reference to FIG. 13.

At 1504, the method may include transmitting, to the UE, a second signaling that indicates to the UE to initiate an early TA procedure for a first candidate cell of the at least one candidate cell. The operations of 1504 may be performed in accordance with examples as described herein. In some implementations, aspects of the operations of 1504 may be performed by a NE as described with reference to FIG. 13.

At 1506, the method may include receiving, from the first candidate cell of the at least one candidate cell, a third signaling indicating a TA value. The operations of 1506 may be performed in accordance with examples as described herein. In some implementations, aspects of the operations of 1506 may be performed a NE as described with reference to FIG. 13.

At 1508, the method may include transmitting, to the UE, a fourth signaling indicating the received TA value. The operations of 1508 may be performed in accordance with examples as described herein. In some implementations, aspects of the operations of 1508 may be performed a NE as described with reference to FIG. 13.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a serving cell, a first signaling that indicates one or more physical random access channel (PRACH) resources and one or more execution conditions for at least one candidate cell;
receive, from the serving cell, a second signaling that indicates to the UE to initiate an early timing advance (TA) procedure for a first candidate cell of the at least one candidate cell;
start a timer; and
transmit, to the first candidate cell, a third signaling that includes a handover complete message if a TA value is received prior to expiration of the timer and the one or more execution conditions for the first candidate cell are satisfied, or invalidate the TA value if the TA value is received after the timer expires.

2. The UE of claim 1, wherein the first signaling indicates a duration of the timer.

3. The UE of claim 1, wherein the first signaling comprises a layer 3 radio resource control (RRC) reconfiguration message.

4. The UE of claim 1, wherein the handover complete message comprises a layer 3 radio resource control (RRC) Reconfiguration complete message.

5. The UE of claim 1, wherein the at least one processor is configured to cause the UE to:
transmit, to the first candidate cell, a fourth signaling that includes a random access channel (RACH) message 1; and
receive, from the serving cell, a fifth signaling that includes the TA value for the first candidate cell.

6. The UE of claim 5, wherein the fifth signaling comprises a lower layer medium access control (MAC) control element (CE) that includes an identification of the first candidate cell including a target frequency and cell identity, a physical beam indication, the timing advance, or a combination thereof for transmitting the third signaling.

7. The UE of claim 1, wherein the at least one processor is configured to cause the UE to:
start the timer in response to the one or more execution conditions for the first candidate cell being satisfied;
evaluate measurements of one or more signals received from the at least one cell; and
determine, based on the measurements, whether the one or more execution conditions for the at least one cell are satisfied.

8. The UE of claim 1, wherein the second signaling comprises a physical downlink control channel (PDCCH) order.

9. The UE of claim 1, wherein the at least one processor is configured to cause the UE to start the timer in response to receiving the TA value from the serving cell.

10. The UE of claim 1, wherein the at least one candidate cell comprises multiple candidate cells, and the at least one processor is configured to cause the UE to:
prioritize the multiple candidate cells according to one or more criteria; and
select, as the first candidate cell, one of the multiple candidate cells having a highest priority.

11. The UE of claim 10, wherein the one or more criteria include an order or sequence of the multiple candidate cells or frequencies of the multiple candidate cells.

12. The UE of claim 10, wherein the one or more criteria include a time of when, for each of the multiple candidate cells, the one or more execution conditions for the candidate cell are satisfied.

13. The UE of claim 10, wherein the one or more criteria include a time of when, for each of the multiple candidate cells, the TA for the candidate cell is received.

14. A base station for wireless communication, comprising:
at least one memory; and
at least one processor coupled with the at least one memory and configured to cause the base station to:
transmit, to a user equipment (UE), a first signaling that indicates a conditional configuration for at least one candidate cell including a timer, one or more physical random access channel (PRACH) resources, and one or more execution conditions for the at least one candidate cell;
transmit, to the UE, a second signaling that indicates to the UE to initiate an early timing advance (TA) procedure for a first candidate cell of the at least one candidate cell;
receive, from the first candidate cell of the at least one candidate cell, a third signaling indicating a TA value; and
transmit, to the UE, a fourth signaling indicating the received TA value.

15. The base station of claim 14, wherein the first signaling indicates a duration of the timer.

16. The base station of claim 14, wherein the fourth signaling comprises a lower layer medium access control (MAC) control element (CE), that includes an identification of the first candidate cell including a target frequency and cell identity, a physical beam indication, the TA, or a combination thereof.

17. A processor for wireless communication, comprising:
at least one controller coupled with at least one memory and configured to cause the processor to:
receive, from a serving cell, a first signaling that indicates one or more physical random access channel (PRACH) resources and one or more execution conditions for at least one candidate cell;
receive, from the serving cell, a second signaling that indicates to the processor to initiate an early timing advance (TA) procedure for a first candidate cell of the at least one candidate cell;
start a timer; and
transmit, to the first candidate cell, a third signaling that includes a handover complete message if a TA value is received prior to expiration of the timer and the one or more execution conditions for the first candidate cell are satisfied, or invalidate the TA value if the TA value is received after the timer expires.

18. The processor of claim 17, wherein the first signaling indicates a duration of the timer.

19. The processor of claim 17, wherein the at least one controller is configured to cause the processor to:
transmit, to the first candidate cell, a fourth signaling that includes a random access channel (RACH) message 1; and
receive, from the serving cell, a fifth signaling that includes the TA value for the first candidate cell.

20. A method performed by a user equipment (UE), the method comprising:
receiving, from a serving cell, a first signaling that indicates one or more physical random access channel (PRACH) resources and one or more execution conditions for at least one candidate cell;
receiving, from the serving cell, a second signaling that indicates to the UE to initiate an early timing advance (TA) procedure for a first candidate cell of the at least one candidate cell;
starting a timer; and
transmitting, to the first candidate cell, a third signaling that includes a handover complete message if a TA value is received prior to expiration of the timer and the one or more execution conditions for the first candidate cell are satisfied, or invalidate the TA value if the TA value is received after the timer expires.
